(19) United States
(12) Patent Application Publication
(10) Pub. No.: US 2026/0115999 A1
(43) Pub. Date: Apr. 30, 2026

(54) Three-Dimensional Printer with Parallel Imaging for High Speed and Resolution

(71) Applicant: 3D Systems, Inc., Rock Hill, SC (US)

(72) Inventor: David Sabo, San Diego, CA (US)

(21) Appl. No.: 19/372,534

(22) Filed: Oct. 29, 2025

Related U.S. Application Data
(60) Provisional application No. 63/713,899, filed on Oct. 30, 2024.

(51) Int. Cl. B29C 64/124; B29C 64/232; B29C 64/236; B29C 64/25; B29C 64/264; B33Y 10/00; B33Y 30/00

(52) U.S. Cl. CPC B29C 64/124; B29C 64/232; B29C 64/236; B29C 64/25; B29C 64/264; B33Y 10/00; B33Y 30/00

(57) ABSTRACT

A three-dimensional (3D) printing system includes a build vessel, a build plate, a horizontal movement mechanism, a light engine, and a controller. The build vessel includes a windowed portion defining a plurality of N openings. The plurality of N openings individually have a major axis along a lateral Y-axis and are spatially separated and arranged along a lateral X-axis. The build vessel includes a transparent sheet that closes the plurality of N openings. The build plate has having a lower surface overlaying and in facing relation with the N openings. The horizontal movement mechanism is configured to impart a change in relative positioning between the windowed portion of the build vessel and the build plate along the lateral X-axis. The light engine is positioned below the build vessel and configured to project pixelated light up through the openings to a build plane above the transparent sheet.

### CROSS-REFERENCE TO RELATED APPLICATIONS

This non-provisional patent application claims priority to U.S. Provisional Application Ser. No. 63/713,899, Entitled “Three-Dimensional Printer with Parallel Imaging for High Speed and Resolution” by David Sabo, filed on Oct. 30, 2024, incorporated herein by reference under the benefit of U.S.C. 119 (e).

### FIELD OF THE INVENTION

The present disclosure concerns an apparatus and method for fabrication of solid three dimensional (3D) articles of manufacture from radiation curable materials. More particularly, the present disclosure concerns an apparatus for rapidly producing customized 3D articles from voxels with linear dimensions of less than 10 microns.

### BACKGROUND

Three dimensional (3D) printers are in rapidly increasing use for manufacturing customized articles. One class of 3D printers includes stereolithography printers having a general principle of operation including the selective curing and hardening of radiation curable (i.e., photocurable) liquid resins. One type of stereolithography system includes a containment vessel holding the curable resin, a movement mechanism coupled to a support tray, and a light engine. The stereolithography system forms a three dimensional (3D) article of manufacture by selectively curing layers of the photocurable resin onto a lower surface of the support tray. There is a desire to produce 3D articles having feature size tolerances that are less than 10 microns, less than five microns, less than 2 microns, or less than one micron in size. Various challenges to fabricating such small geometries include limitations on the optical and mechanical systems that are historically suitable for tolerances that are more in a range of 20 microns or larger. Most prior art stereolithography printers have a voxel size or resolution limit of larger than about 10 to 20 micron linear dimensions. Also, as the voxel sizes of systems becomes smaller, the productivity typically decreases. There is considerable value in driving the vectors of small feature size and productivity in stereolithography systems, but this has not been realized in prior art systems.

### SUMMARY

In a first aspect of the disclosure, a three-dimensional (3D) printing system is configured to fabricate a three-dimensional (3D) article of manufacture. The 3D printing system includes a build vessel, a build plate, a horizontal movement mechanism, a light engine, and a controller. The build vessel includes a windowed portion defining a plurality of N openings. The plurality of N openings individually have a major axis along a lateral Y-axis and are spatially separated and arranged along a lateral X-axis. The build vessel includes a transparent sheet that closes the plurality of N openings. The build plate has having a lower surface overlaying and in facing relation with the N openings. The horizontal movement mechanism is configured to impart a change in relative positioning between the windowed portion of the build vessel and the build plate along the lateral X-axis. The light engine is positioned below the build vessel and configured to project pixelated light up through the N openings to a build plane above the transparent sheet. The controller is programmed to operate a vertical movement mechanism to position a lower face of the 3D article to be coplanar with the build plane, operate the horizontal movement mechanism to impart the relative motion between the windowed portion of the build vessel and the build plate along the lateral X-axis, and operate the light engine to simultaneously irradiate the build plane in N spatially separated stripes that correspond to the N openings and to selectively image the build plane through a continuous or stepwise irradiation of positions along the build plane as the horizontal movement mechanism imparts the relative motion.

In an implementation, N is greater than 2. In a particular implementation, N equals 3. The transparent sheet includes N spatially separated transparent sheets that individually correspond to and close the N openings. The projection light engine includes N separate projectors that individually correspond to the N openings.

In another implementation, the controller operates the horizontal movement mechanism to continuously impart the relative positioning with relative motion between the windowed portion of the build vessel and the build plate. Concurrently, the controller operates the light engine to continuously irradiate the build plane with the N spaced apart stripes during the relative motion.

In yet another implementation, the controller operates the horizontal movement mechanism to impart the relative positioning in a series of steps in a start/stop motion. The controller operates the light engine to irradiate a fixed stripe of the build plane during each stop. The controller can operate a second horizontal movement mechanism to impart relative motion between the light engine and the windowed portion of the build vessel during the irradiation.

In a further implementation, the windowed portion of the build vessel is mounted to a linear bearing for controlled motion along the X-axis. The windowed portion of the build vessel is mechanically coupled to the light engine. The second horizontal movement mechanism moves the light engine in tandem with the windowed portion of the build vessel along the X-axis.

In another implementation, N clear transparent plates are individually positioned in the N openings. The transparent sheet includes N transparent sheets individually tensioned over the N clear transparent plates.

In a second aspect of the disclosure, a three-dimensional (3D) printing system is configured to fabricate a three-dimensional (3D) article of manufacture. The three-dimensional (3D) printing system includes a machine base, a build vessel, a horizontal movement mechanism, a build plate overlaying the build vessel, a vertical movement mechanism coupled to the build plate, a light engine, and a controller. The build vessel includes a lower portion and a windowed portion. The lower portion is configured to be received and aligned onto the machine base and includes including a carriage mounted to the lower portion by a linear bearing for translation along a lateral X-axis. The windowed portion is configured to be received on the carriage and defines a plurality of N windows. The windowed portion includes a transparent sheet that that closes the N windows. The N windows individually have a major axis aligned with the lateral Y-axis and are arranged and spaced along the lateral X-axis. The light engine is positioned below the build vessel and configured to project radiation upward through the plurality of N openings to a contiguous build plane. The controller is programmed to operate the vertical movement mechanism to position a lower face of the 3D article to be coplanar with the build plane, operate the horizontal movement mechanism to either continuously or stepwise translate the carriage along the lateral X-axis as the N openings individually span portions of the build plane and allow access of radiation to light engine to the full build plane, operate the light engine either continuous or stepwise to selectively irradiate the build plane to form a new layer onto the lower face of the 3D article.

In one implementation, the windowed portion includes an outer frame with a central opening and a window assembly that closes the central opening. The window assembly defines the plurality of N windows and further includes a tension lip.

that at least partially surrounds a window of the N windows, and a transparent plate supported within the window below the transparent sheet. The window assembly is configured to tension the transparent sheet over the tension lip. The transparent sheet includes N transparent sheets individually supported around the N windows. The carriage includes a plurality of level adjusters configured to impinge upon the window assembly to individually adjust a height and planarity of a transparent plate.

### BRIEF DESCRIPTION OF THE FIGURES

FIG. 1 is an isometric drawing of a three-dimensional (3D) printing system for fabricating a three-dimensional (3D) article with an outer housing removed to reveal certain internal components.

FIG. 2A is an isometric cutaway view of a windowed portion of a build vessel defining three windows that are closed by transparent sheets.

FIG. 2B is similar to FIG. 2A with additional components including a window assembly and a transparent plate underlying each of the transparent sheets.

FIG. 2C is similar to FIG. 2B with a lower portion of the build vessel included.

FIG. 3 is a detailed cutaway view of a portion of the windowed portion of the build vessel for illustrating a fluid inlet and conduits for applying air pressure modulation between a transparent plate and a transparent sheet.

FIG. 4 is an isometric view of a lower or bottom side of a windowed portion of a build vessel.

FIG. 5A is an isometric view of an upper or top side of a lower portion of a build vessel.

FIG. 5B is an isometric view of a lower or bottom side of a lower portion of a build vessel.

FIG. 6 is an isometric drawing of a three-dimensional (3D) printing system for fabricating a three-dimensional (3D) article with an outer housing removed to reveal certain internal components. FIG. 6 is similar to FIG. 1 except that a build platform and build vessel have been removed to further review certain components.

FIG. 7 is a simplified electrical block diagram of a three dimensional (3D) printing system.

FIG. 8 is a flowchart depicting a simplified version of a method for operating a 3D printing system to manufacture a 3D article.

FIG. 9A is a schematic diagram that depicts an overlay of a build plate over a windowed portion of a build vessel. The relative location of the build plate to the windowed portion is a starting position.

FIG. 9B is a schematic diagram that depicts an overlay of a build plate over a windowed portion of a build vessel. The relative location of the build plate to the windowed portion is an intermediate position.

FIG. 9C is a schematic diagram that depicts an overlay of a build plate over a windowed portion of a build vessel. The relative location of the build plate to the windowed portion is an ending position.

FIG. 10 is a flowchart depicting an embodiment of a method for operating a 3D printing system to manufacture a 3D article.

### DETAILED DESCRIPTION OF THE PREFERRED EMBODIMENTS

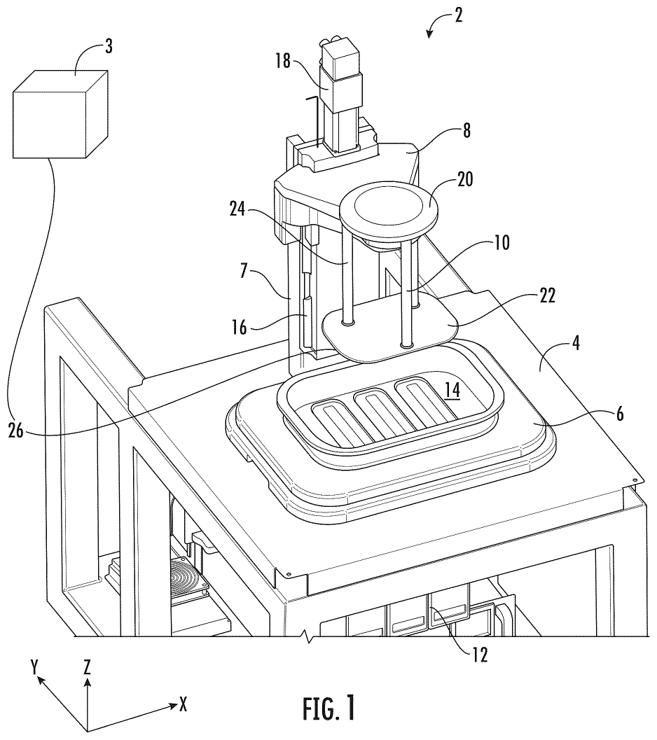

FIG. 1 is an isometric drawing depicting an embodiment of three-dimensional (3D) printing system 2 configured to manufacture a three-dimensional (3D) article 3. In describing 3D system 2, mutually perpendicular axes X, Y, and Z will be used. Axes X and Y are generally horizontal or lateral axes. Axis Z is a vertical axis that is generally aligned with a gravitational reference. In using the word “generally” it is implied that a limitation that is “generally” true is by design but to within manufacturing tolerances. Additionally angular axes theta-X, theta-Y, and theta-Z are rotations about the X, Y, and Z axes respectively. In the figures that follow, like element numbers indicate like elements although the same element number may be used for different embodiments or implementations of the same element.

3D printing system 2 includes a machine base or chassis 4 for supporting a build vessel 6, a vertical support 7, an elevator 8, a build platform 10, a light engine 12, and other mechanical and electromechanical components of the 3D printing system 2. The build vessel 6 is configured to contain a photocurable resin 14. Photocurable resin 14 is a liquid polymeric material configured to be selectively hardened with an application of radiation having a wavelength in the blue to ultraviolet range or within a range of 100 to 500 nanometers (nm). The photocurable resin generally contains a monomer and catalyst. The catalyst facilitates polymerization and/or crosslinking of the monomer in response to being irradiated. Photocurable resin 14 can also include other components such as colorants, fillers, and additional polymeric materials. Photocurable resins 14 are generally known in the field of 3D printing of plastics and biologic 3D articles 3.

The elevator 8 is slidingly mounted to the vertical support 7 with linear bearings 16. Linear bearings 16 accurately constrain motion of the elevator to the vertical Z-axis. A vertical movement mechanism 18 is configured to controllably position the elevator 10 along the Z-axis. An embodiment of the vertical movement mechanism 18 includes a motorized ball bearing screw mechanism or otherwise referred to as a ball screw mechanism. A ball screw mechanism includes a vertical screw shaft that passes through a ball nut. The ball nut contains recirculating steel balls and translates vertically. The vertical screw shaft has helical channels that engage the recirculating balls. The elevator 8 includes the ball nut. A motor is coupled to the vertical screw shaft and is configured to selectively rotate the vertical screw shaft. As the vertical screw shaft rotates, the action of the vertical screw shaft upon the ball nut translates the elevator 8 upward and downward depending on a direction of rotation. Such translation mechanisms are known in the art for precision positioning along vertical, horizontal, and oblique axes. Other embodiments are possible such as a lead screw and nut system or a rack and pinion mechanism or a motorized belt/pulley system and are all known in the art for linearly translating components along various axes.

The build platform 10 includes an upper portion 20 coupled to a build plate 22 by rods 24. The build plate 22 has a lower side 26 or lower surface 26 for supporting a 3D article 3. Element 26 can also be referred to as a “lower face” 26 of the 3D article 3 being formed or the build plate 22 during a layer-by-layer formation of the 3D article 3.

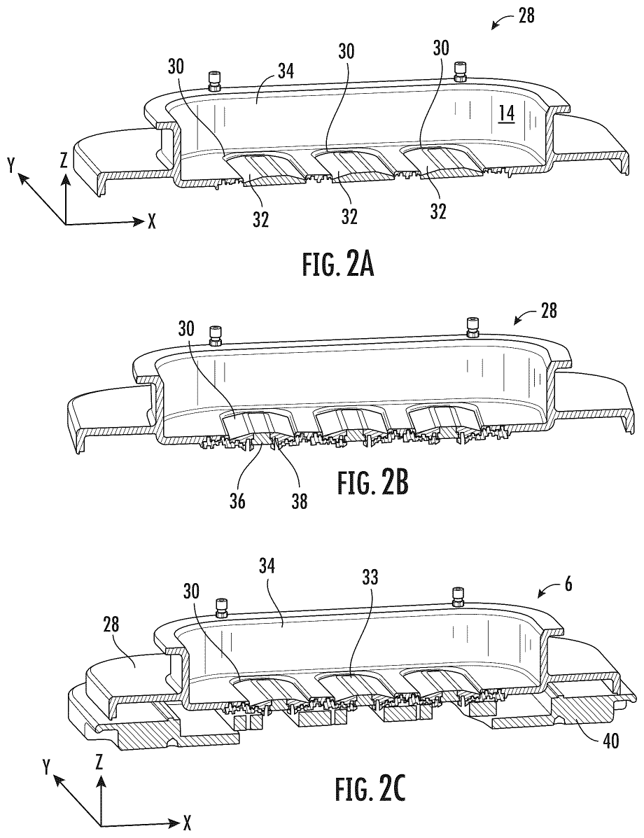

FIGS. 2A-C illustrate portions of the build vessel 6. FIG. 2A illustrates a “windowed” portion 28 of the build vessel 6. The windowed portion 28 defines three openings 30. The three openings 30 are closed by a transparent sheet 32 or by three separate transparent sheets 32. The windowed portion 28 also includes vertical wall 34. The windowed portion 28 and the transparent sheet(s) 32 cooperate to contain the photocurable resin 14. In the illustrated embodiment, the transparent sheet 32 includes three separate transparent sheets 32 that individually close the openings 30. The openings 30 are spatially separated or spaced apart from each other with respect to the lateral X-axis. The openings 30 individually have a major lateral axis along the Y-axis and a minor lateral axis along the X-axis.

FIG. 2B illustrates the windowed portion 28 including transparent plates 36 and tension lips 38. The transparent plates 36 are each individually within one of the openings 30. One transparent sheet 32 is stretched over a transparent plate 36 and over the tension lips 38.

The transparent sheet 32 is “semipermeable” in that it is transmissive of an inhibitor such as oxygen. The transparent sheet 32 is “transparent” in the sense that it is transparent to radiation in blue to ultraviolet wavelengths or 500 nm (nanometers) to 100 nm. One example of a suitable transparent sheet is a fluoropolymer with optical clarity and gas permeability such as Teflon™ AF 2400. Other polymeric sheet materials can be suitable for the particular application.

The transparent plate 36 is similarly transparent to radiation in blue to ultraviolet wavelengths or 500 nm (nanometers) to 100 nm. The transparent plate 36 is formed from a rigid material such as glass, quartz, or a high modulus but transparent polymer to name some examples.

FIG. 2C illustrates the build vessel 6 including a lower portion 40 supporting the windowed portion 28. As will be discussed infra, the windowed portion 28 is configured to be translated over the lower portion 40 along the X-axis. Moreover, one or two linear bearings having linearly constrained travel along the X-axis couple the windowed portion 28 to the lower portion 40.

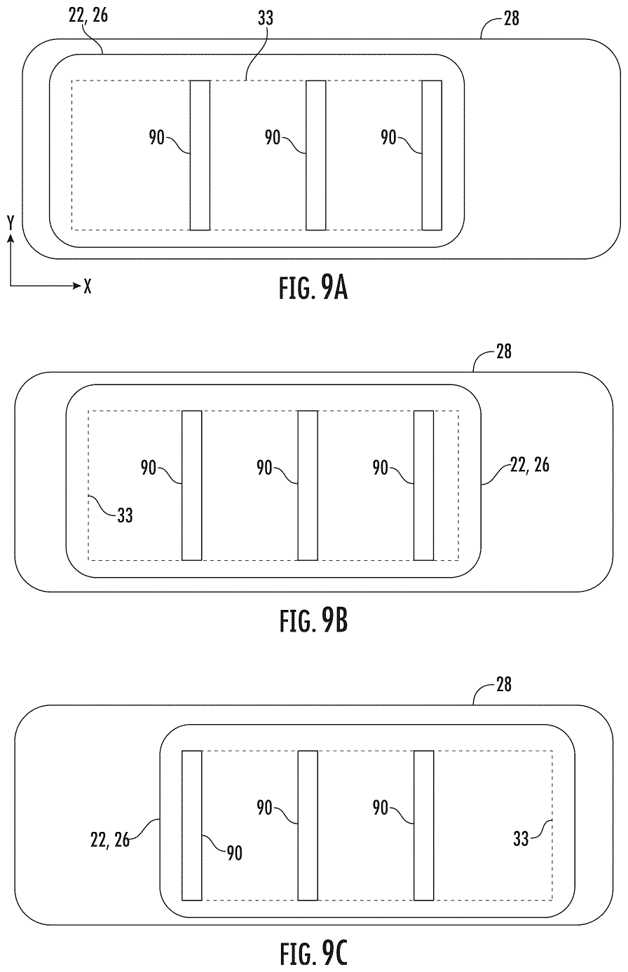

During operation, the build vessel 6 contains the photocurable resin 14. A build plane 33 is locationally defined above the transparent sheet 32 based in part upon action of the inhibitor (oxygen) and the light engine 12. The build plane 33 is at a height in Z at which radiation selectively hardens a new layer of the 3D article 3. The application of radiation is in the form of rectangular stripes 90 (to be further described infra with respect to FIGS. 9A-C). A rectangular stripe 90 has lateral (XY) dimensions that are smaller than the windows 30 and smaller in lateral area than the transparent plate 36. A lateral dimension of the rectangular stripe 90 is defined and limited by the light engine 12. The rectangular stripe 90 of applied radiation is coplanar with the build plane 33 for a portion of the build plane 33. The height of the build plane 33 is coplanar with or one layer thickness below the lower face 26.

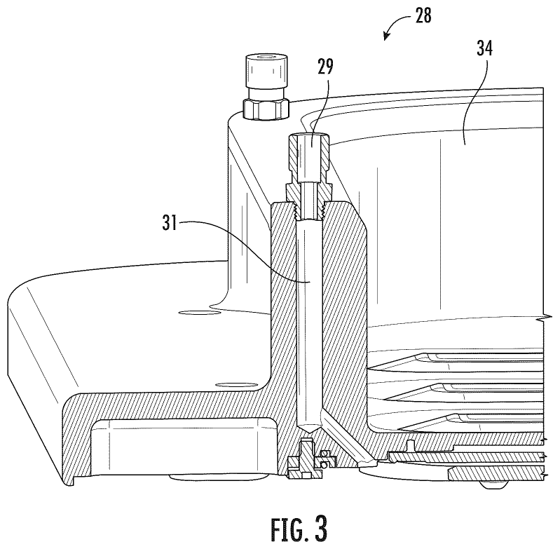

FIG. 3 is a detailed cutaway isometric view of a portion of the windowed portion 28 of the build vessel 6. A fluid port 29 is coupled to a fluid conduit 31 that is internal to the windowed portion 28 and is in turn coupled to a space between the transparent sheet 32 and the transparent plate 36. The fluid port 29 allows air pressure to be applied to the transparent sheet 32 to replenish oxygen along a lower surface of the transparent sheet 32.

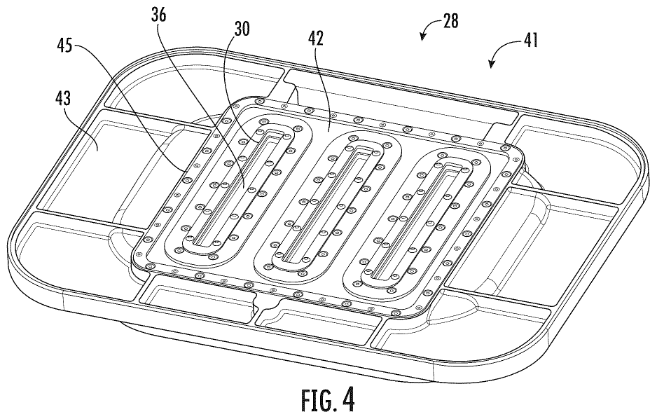

FIG. 4 is an isometric view of a lower or bottom side 41 of the windowed portion 28 of the build vessel 6. The windowed portion 28 includes an outer frame 43 defining a central rectangular window 45. A window assembly 42 closes the central rectangular window 45 and defines the windows 30, individually supports a transparent plate 36 in each window, and defines a tension lip 38 (FIG. 2B) surrounding or at least partially surrounding each window 30. The window assembly 42 also clamps and tensions each of the three transparent sheets 32 over a transparent plate 36 and its surrounding tension lip 38.

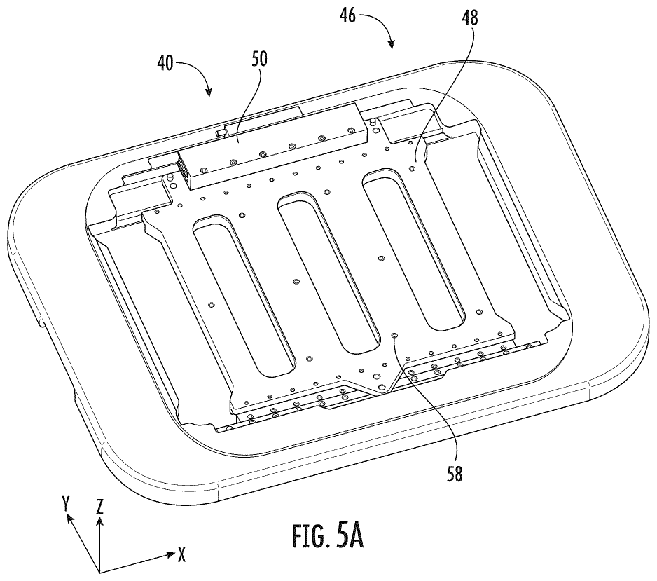

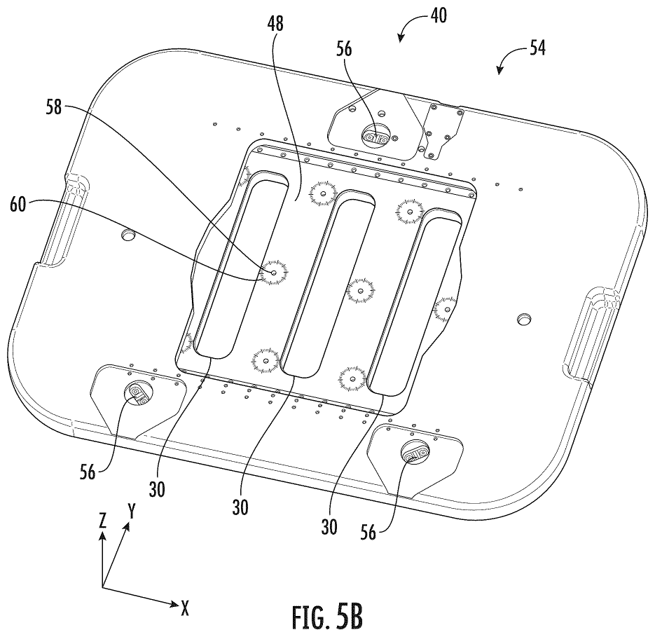

FIG. 5A is an isometric view of an upper or top side 46 of the lower portion 40 of the build vessel 6. The lower portion includes a carriage or linear stage 48 that slidingly coupled to the top side 46 by linear bearing(s) 50. The carriage 48 is constrained by the bearing(s) to move or slide along the lateral X-axis. The lower side 41 of the windowed portion 28 is loaded onto and in facing relation with the upper side 46 of the lower portion 40 of build vessel 6. The windowed portion 28 is accurately mounted and secured to the linear stage 48 with datums and/or screws. The windowed portion 28 is thus slidingly mounted to the lower portion 40 via the carriage 48 to be constrained to slide above the lower portion 40 along the X-axis.

FIG. 5B is an isometric view of a lower or bottom side 54 of the lower portion 40 of the build vessel 6. The lower side 54 includes three datum grooves 56. Also illustrated in FIGS. 4 and 5 are a plurality of nine level adjusters 58—three for each of the openings 30. For each level adjuster 58, the pitch, roll, and height of the transparent plate 36 and transparent sheet 32 can be adjusted within each opening 30. In the illustrated embodiment, each level adjuster 58 includes a fine pitch screw received into a threaded bushing. The fine pitch screw presses against a surface of the window assembly 42. The window assembly 42 has a degree of flexibility to facilitate adjustment. The fine pitch screw can be manually adjusted. In an alternative embodiment, the fine pitch screws can be motorized. The illustrated level adjuster 58 includes a circle 60 of tick marks to facilitate manual adjustment. In the illustrated embodiment, a single tick mark corresponds to a one micron height adjustment.

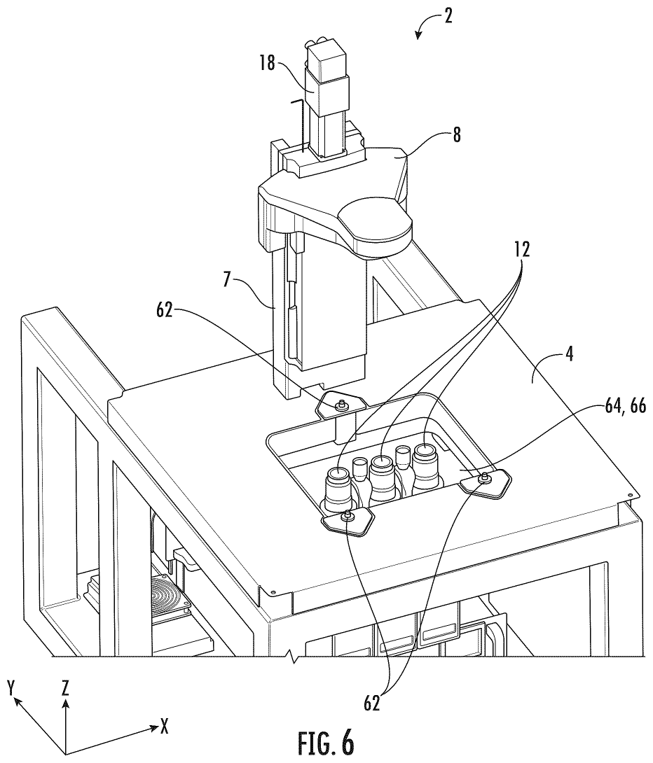

FIG. 6 is an isometric view of the 3D printing system 2 with the build vessel 6 and build platform 10 removed. The 3D printing system includes three leveling actuators 62 that are individually configured to engage the three datum V-grooves 56 on the lower side 54 of the lower portion 40. Engagement of the leveling actuators 62 with the V-grooves 54 constrains a location and orientation of the build vessel 6. The leveling actuators 62 individually include a spherical-tipped and threaded pin. A threaded bushing or gear receives the threaded pin and is coupled to a motor. Rotation of the motor thereby drives the pin up and down and thus drives an upper spherical tip of the pin up and down against the V-groove.

In the illustrated embodiment, the light engine 12 includes three projection light engines 12 that are arranged along the lateral X-axis. Below the light engines 12 is a pair of lateral movement mechanisms including a first lateral movement mechanism 64 and a second lateral movement mechanism 66.

The first movement mechanism 64 is configured to position the light engine 12 and the windowed portion 28 of the build vessel 6 along the lateral X-axis. In the illustrated embodiment, the first lateral movement mechanism 64 positions and moves the light engine 12 and windowed portion 28 in tandem. The second lateral movement mechanism 66 is configured to position and move the light engine 12 relative to the windowed portion 28 along the Y-axis.

In one embodiment, the movement mechanisms 64 and 66 each include a fixed linear or stepper motor turning a lead screw. The lead screw engages inner threads of a nut. The nut is coupled to the portion or portions that is to be moved and positioned. Thus, rotational motion of the motor causes linear translation of the portion or portions that to be moved and positioned. In an alternative embodiment, a motor can drive a gear train that is coupled to a linear gear—otherwise known as a gear-reduction rack and pinion movement mechanism. Precision motor-driven movement mechanisms are known in the art for systems requiring automated and precision positioning of components.

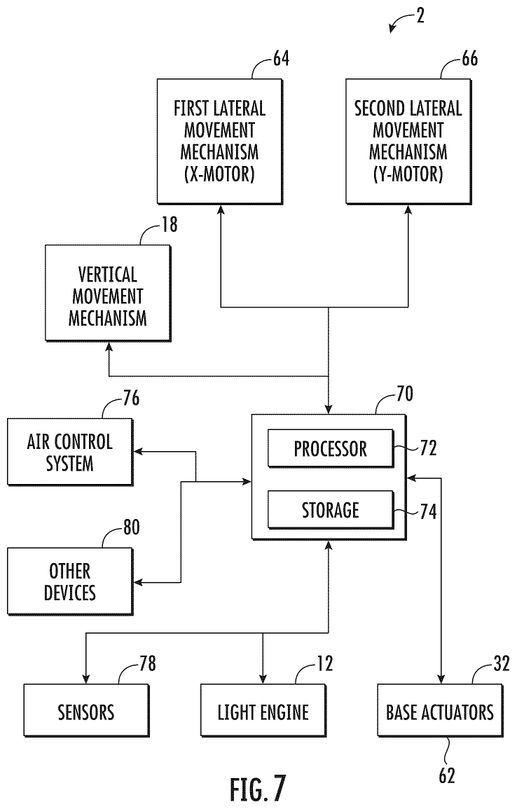

FIG. 7 is a simplified electrical block diagram of the three-dimensional (3D) printing system 2. A controller 70 is coupled to various electrically controlled components of the (3D) printing system 2. Controller 70 includes a processor 72 coupled to a storage device 74. Storage device 74 includes a non-transient or non-volatile storage device 74 such as a hard drive or flash memory. The non-transient or non-volatile storage device 74 stores software instructions that, when executed by the processor 72, receive information from and operate various components of the 3D printing system 2. Controller 70 can be a single microcontroller that is physically within a housing of 3D printing system 2. However, in an illustrative embodiment, controller 70 includes controllers that are both internal and external to the 3D printing system 2. The external controllers can include one or more of desktop computers, laptop computers, smartphones, computer servers, mainframe computers, and other computing devices that are proximate to or remotely located relative to the housing of the 3D printing system 2.

Some components of 3D printing system 2 coupled to controller 70 have been described earlier, such as light engine 12, vertical movement mechanism 18, base actuators 62, first lateral movement mechanism 64, and second lateral movement mechanism 66. The air control system 76 is configured to selectively apply positive and negative gauge pressures to a space between the transparent sheet 32 and the transparent plate 36 using devices that can include one or more of a peristaltic pump, a piston pump, a syringe pump, a diaphragm pump, and a vacuum chamber, and an electromechanical valve, to name a few examples. The positive gauge pressure can be used to replenish an oxygen supply to the transparent sheet 32. The negative gauge pressure can be used to flatten the transparent sheet 32 against the transparent plate 36. Referring back to FIG. 3, the air control system 76 applies air pressure modulation to the conduit 31 via the fluid port 29.

The system 2 can includes various sensors 78 including one or more of load cells, force sensors, optical sensors, confocal sensors, displacement sensors, and pressure sensors, to name a few examples. For example, a load cell in the elevator 8 can be used to infer forces being exerted on the build plate 22 by the resin 14. System 2 can also include other devices 80 such as additional actuators, magnets (for holding the build platform 10 to the elevator 8), additional motors, to name some examples.

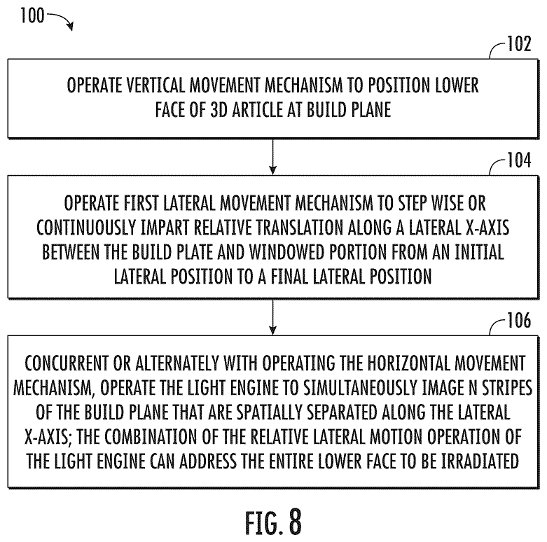

FIG. 8 is a flowchart depicting a general method 100 of the 3D printing system 2 in forming a layer of 3D article 3. Controller 70 is programmed to perform the steps of method 100. According to 102, the vertical movement mechanism 18 is operated to position a lower face 26 of the 3D article 3 (or initially the build plate 22) at the build plane 33.

According to 104, the first lateral movement mechanism 64 is operated to step wise or continuously impart relative translation along the lateral X-axis between the build plate 22 and the windowed portion of the build vessel from an initial lateral position and a final lateral position along X. This motion allows the irradiation stripes that are transmitted through windows 30 to laterally cover an entire area of the build plane 33 through a process of sequential illumination.

According to 106—concurrent with or alternately with operating the horizontal movement mechanism—operate the light engine to simultaneously image N (three in illustrated embodiment) rectangular stripes. The N stripes are spatially separated along the lateral X-axis. The combination of steps 104 and 106 allows the entire build plane 33 to be selectively irradiated in either a stepwise or continuous mode.

FIGS. 9A-C illustrate method 100 and method 200 to be described infra in diagram form. FIG. 9A illustrates a start of a sequence. Element 26 represents an area of a lower side of a build plate 22. Build plane 33 covers an entire lower face area to be selectively irradiated. Element 33 can also be referred to as a “composite build plane” 33. Element 90 represents the rectangular stripe 90 to be selectively irradiated. In FIG. 9A, the three spatially separated stripes 90 are irradiated.

Then, in FIG. 9B, the relative position of the windowed portion 28 and stripes 90 are moved in the −X direction and a new stripe 90 of the composite build plane 33 is irradiated. FIG. 9C shows the last stripe 90 to be irradiated. In proceeding from step 9A to 9C, the relative motion between the build plate 22 and the stripes 90 being irradiated can be accomplished either stepwise or continuously. With continuous irradiation, the stripes 90 continuously move across the composite build plane 33 while pixelated radiation is applied to selectively harden photocurable resin 14 at the build plane 33 as desired.

FIGS. 9A-9C illustrate relative motion between the build plate 22 and the windowed portion 28. In the illustrative embodiment, the build plate 22 and build plane 33 are fixed while the windowed portion 28 is being translated and stepped along the X-axis. In an alternative embodiment, the build plate 22 can be translated while the windowed portion 28 is fixed.

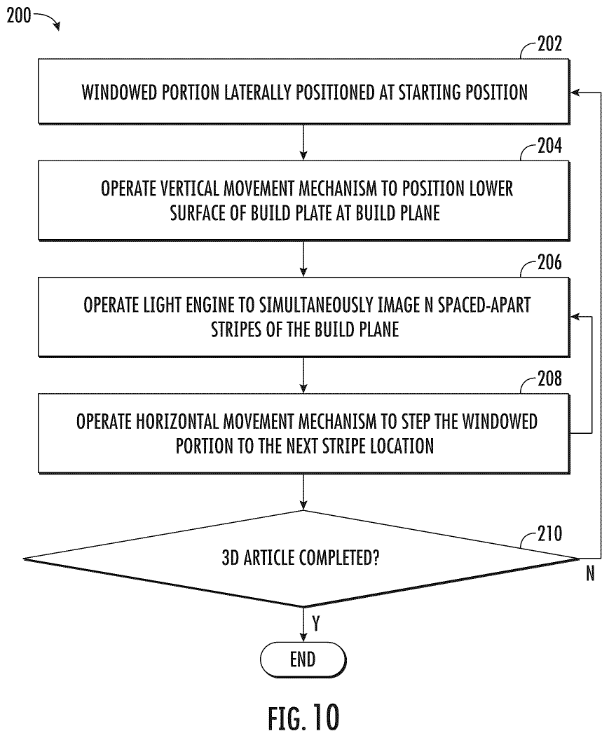

FIG. 10 is a flowchart depicting a method 200 for stepwise imaging a composite build plane 33. Method 200 utilizes a translatable window portion 28 of a build vessel 6 with a fixed build plate 22.

According to 202, the windowed portion 28 of the build vessel 6 is laterally positioned at a starting position. This is schematically illustrated in FIG. 9A. According to 204, the vertical movement mechanism 18 is operated to place the lower face 26 of the 3D article 3 (or initially the build plate 22) to be coplanar with the build plane 33.

According to 206, the light engine 12 is operated to simultaneously image the N spaced apart stripes 90. According to 208, the first lateral movement mechanism 64 is operated to step the windowed portion 28 by a width of one stripe 90 to allow a next set of stripes 90 to be irradiated. Steps 206 and 208 are repeated until the entire build plane 33 has been selectively irradiated.

According to 210, a determination is made as to whether all layers of the 3D article have been selectively formed. If not, the process loops back to step 202. If so, the process ends.

As a note, step 206 can include a second movement mechanism scanning light engine 12 projectors along the Y-axis. Alternatively, the light engine 12 can be configured to image the entire stripe 90 at once.

The specific embodiments and applications thereof described above are for illustrative purposes only and do not preclude modifications and variations encompassed by the scope of the following claims.

What is claimed:

1. A three-dimensional (3D) printing system for fabricating a 3D article comprising:
a build vessel having a windowed portion defining a plurality of N openings individually having a major axis along a lateral Y-axis, a minor axis along a lateral X-axis, and spatially separated along the X-axis, the build vessel including a transparent sheet that closes the plurality of N openings;
a build plate having a lower surface overlaying and in facing relation with the N openings;
a horizontal movement mechanism configured to impart a change in relative positioning between the windowed portion of the build vessel and the build plate along the lateral X-axis;
a light engine positioned below the build vessel and configured to project pixelated light up through the openings to a build plane above the transparent sheet; and
a controller programmed to:
operate a vertical movement mechanism to position a lower face of the 3D article to be coplanar with the build plane;
operate the horizontal movement mechanism to impart the relative motion between the windowed portion of the build vessel and the build plate along the lateral X-axis; and
operate the light engine to simultaneously irradiate the build plane in N spatially separated stripes that correspond to the N openings and to selectively image the build plane through a continuous or stepwise irradiation of positions along the build plane as the horizontal movement mechanism imparts the relative motion.

2. The three-dimensional (3D) printing system of claim 1 wherein N equals three.

3. The three-dimensional (3D) printing system of claim 1 wherein the transparent sheet includes N spatially separated transparent sheets that individually correspond to and close the N openings.

4. The three-dimensional (3D) printing system of claim 1 wherein the projection light engine includes N separate projectors that individually correspond to the N openings.

5. The three-dimensional (3D) printing system of claim 1 wherein the controller operates the horizontal movement mechanism to continuously impart the relative positioning with relative motion between the windowed portion of the build vessel and the build plate and concurrently operates the light engine to continuously irradiate the build plane with the N spatially separated stripes during the relative motion.

6. The three-dimensional (3D) printing system of claim 1 wherein the controller operates the horizontal movement mechanism to impart the relative positioning in a series of steps having a step with equal to or less than a width of one of the stripes, the irradiation occurring when the relative motion is paused between steps.

7. The three-dimensional (3D) printing system of claim 6 wherein the controller operates a second horizontal movement mechanism to impart relative motion between the light engine and the windowed portion of the build vessel when the relative motion is paused between steps.

8. The three-dimensional (3D) printing system of claim 1 wherein the windowed portion of the build vessel is mounted to a linear bearing for controlled motion along the X-axis.

9. The three-dimensional (3D) printing system of claim 8 wherein the windowed portion of the build vessel is coupled to the light engine, the horizontal movement mechanism moves the light engine in tandem with the windowed portion of the build vessel along the X-axis.

10. The three-dimensional (3D) printing system of claim 1 wherein a second horizontal movement mechanism is configured to impart relative motion between the light engine and the windowed portion of the build vessel long the Y-axis.

11. The three-dimensional (3D) printing system of claim 1 wherein N clear transparent plates are individually positioned in the N openings, the transparent sheet includes N transparent sheets individually tensioned over the N clear transparent plates.

12. A three-dimensional (3D) printing system for fabricating a 3D article comprising:
a machine base;
a build vessel including:
a lower portion configured to be received and aligned onto the machine base, the lower portion including a carriage mounted to the lower portion by a linear bearing for translation along a lateral X-axis;
a windowed portion aligned and mounted to the carriage, the windowed portion defining a plurality of N openings and including a transparent sheet that closes the N openings, the N openings individually having a major axis aligned with a lateral Y-axis and arranged and spaced part along the lateral X-axis;
a horizontal movement mechanism coupled to the carriage;
a build plate overlaying the build vessel;
a vertical movement mechanism coupled to the build plate;
a light engine positioned below the build vessel and configured to project radiation upward through the plurality of N openings to a contiguous build plane;
a controller programmed to:
operate the vertical movement mechanism to position a lower face of the 3D article to be coplanar with the build plane;
operate the horizontal movement mechanism to either continuously or stepwise translate the carriage along the lateral X-axis as the N openings individually span portions of the build plane and allow access of radiation to light engine to the full build plane; and
operate the light engine either continuous or stepwise to selectively irradiate the build plane to form a new layer onto the lower face of the 3D article.

13. The three-dimensional (3D) printing system of claim 1 wherein the windowed portion of the build vessel includes an outer frame with a central opening and a window assembly that closes the central opening, the window assembly defines the N openings and further includes:
a tension lip that at least partially surrounds an opening of the N openings; and
a transparent plate supported within the opening below the transparent sheet, the window assembly is configured to tension the transparent sheet over the tension lip and the transparent plate.

14. The three-dimensional (3D) printing system of claim 13 wherein the transparent sheet includes N transparent sheets individually supported around the N windows.

15. The three-dimensional (3D) printing system of claim 13 wherein the carriage includes a plurality of level adjusters configured to impinge upon the window assembly to individually adjust a height and planarity of a transparent plate.

16. The three-dimensional (3D) printing system of claim 12 wherein the carriage has an upper side having a plurality of datums, the windowed assembly has a corresponding plurality of datums that are configured to engage the plurality of datums of the carriage to align the windowed assembly to the carriage.

17. The three-dimensional (3D) printing system of claim 12 wherein the horizontal movement mechanism is configured to translate and position the carriage and the light engine in tandem along the lateral X-axis.

18. The three-dimensional (3D) printing system of claim 17 further comprising a second horizontal movement mechanism configured to translate the light engine along the lateral Y-axis relative to the carriage.
